(19) United States
(12) Patent Application Publication
(10) Pub. No.: US 2011/0257977 A1
(43) Pub. Date: Oct. 20, 2011

(54) COLLABORATIVE AUGMENTATIVE AND ALTERNATIVE COMMUNICATION SYSTEM

(75) Inventors: Leonard A. Greenberg, Cupertino, CA (US); Philip G. Bookman, Los Gatos, CA (US)

(73) Assignee: ASSISTYX LLC, Cupertino, CA (US)

(21) Appl. No.: 13/171,866

(22) Filed: Jun. 29, 2011

Related U.S. Application Data
(60) Provisional application No. 61/370,417, filed on Aug. 3, 2010.

(51) Int. Cl. G10L 11/00; G06F 3/01; G06F 3/16

(52) U.S. Cl. 704/271; 715/727; 704/E11.001

(57) ABSTRACT

A system and method for presenting and editing associations between graphics and audio useful for assisting people who have difficulty in speaking. This may include presenting graphics and audio information together with topic information thus allowing for a user to create outlines of speech needed for different events and situations. When a user selects a topic, images appear and by selecting the image a device is instructed to play the associated audio file. Images and audio may be outlined into useful constructs to provide for differing situations and multiple users may edit those outlines. Moreover, the constructs, may be published to devices and other systems. In accordance with certain embodiments, images and audio files may be uploaded or purchased from vendors. Collaboration provides the speech impaired with the ability to develop a progressively improving speech vocabulary and to share that vocabulary with others needing assistance.

### PRIORITY

This application claims the benefit of U.S. provisional patent application 61/370,417 entitled “Collaborative Programming and Publishing of Augmentative and Alternative Communication Content” by the same inventors, filed Aug. 3, 2010.

### BACKGROUND

There is a growing population of people who for a variety of medical and psychological reasons cannot speak or whose speech cannot be understood by others. Recognizable examples are children with autism, adults who have had strokes and people who have cerebral palsy. Professionals who work with such people use a variety of tools and techniques that allow them to communicate with others. These techniques are generally called Augmentative and Alternative Communications (AAC).

One area of AAC deals with using assist devices, such as computers or other custom devices, which allow the non-verbal child or adult to communicate by tapping a picture or typing a phrase. These actions trigger either a recorded or computer-generated voice in the device to “speak” on the person's behalf. The vocabulary on these devices must be programmed using some method unique to the device in order to individualize the pictures and sound output appropriate for the individual. For example, a non-verbal person may need to communicate that they are hungry and want a particular food. In this case, the device is programmed with pictures and recorded phrases of that person's favorites. Regardless of simplicity or complexity of device, the current model is to program on the device itself. Whether a proprietary and expensive AAC device or less expensive AAC software that runs on general purpose hardware such as a smart phone, programming and configuration takes place on the device. Thus, the programming required to individualize AAC content for a non-verbal person can only be done by one person, often a technical specialist who may or may not be familiar with the non-verbal end user.

This “program on the device” model does not take into account the dynamic nature of speech and the ongoing improvements and additions to the programming/vocabulary that need to take place rapidly as a child or adult learns to use the device. It also does not take into account that many people are part of the process of building the vocabulary: a parent (or other primary caregiver), a speech and language professional (SLP), a behavioral specialist and the non-verbal person themselves.

### SUMMARY

Disclosed herein is a system and method for presenting and editing associations between graphics and audio files useful for assisting people who have difficulty in speaking. This may include presenting graphics and audio information together with topic information thus allowing for a user to create outlines of speech needed for different events and situations. When a user selects a topic, images appear and by selecting the image a device is instructed to play the associated audio file. Images and audio, (and at times text) known as a Picture object, may be outlined into useful constructs to provide for differing situations and allowing for multiple users to edit those outlines. Moreover, the constructs, known as albums (or vocabularies), may be published to devices and other systems. In accordance with certain embodiments, picture objects may be uploaded or purchased from vendors. Additionally, audio may be generated using text to speech software.

Also disclosed is a display engine operative to receive a graphic from many sources and to receive an audio file. The display engine then associates the graphic and audio file to a topic. Once associated an execution engine persists the picture object and topic in non-transitory memory, and publishes the picture object and topic as an album. The album, or a collection of albums may be otherwise edited collaboratively by other users such as caregivers. In addition the many users can create customizable outlines of albums thus providing the speech impaired the ability to develop a progressively improving speech vocabulary and to share that vocabulary with others needing assistance.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system that may be employed for some embodiments according to the current disclosure.

FIG. 2 shows an embodiment of a picture library.

FIG. 3 illustrates a sound library.

FIG. 4 shows an embodiment of an album outliner.

FIG. 5 shows a method for collaboration.

FIG. 6 shows an embodiment of collaborative sharing.

FIG. 7 shows a diagram representing an embodiment of a collaboration model.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

The term “wireless device” generally refers to an electronic device having communication capability using radio, optics and the like.

### DETAILED DESCRIPTION

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays, microphones, cameras and the like. Moreover remote connected computer systems, modems, radio transmitters and handheld personal communication devices such as cellular phones, “smart phones”, digital assistants and the like may be employed.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

### Client Server Processing

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

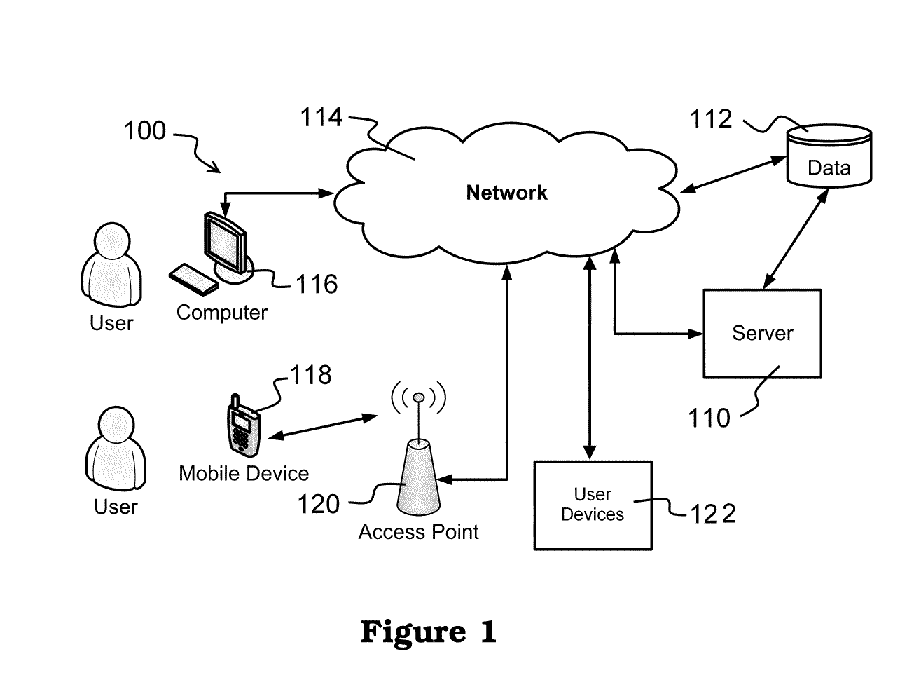

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

One having skill in the art will recognize that there are many user devices 122 that may interact with the user and a network 114. These devices include, but are not limited to game systems such as Nintendo DS, iPad and other tablet computers, Android phones, eReaders (such as the Nook Color from Barnes and Noble), RIM Playbooks, Windows based tablets, Chromebook compliant machines, smartboards and the like.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Structured Data

ACC information may be recorded (or persisted) in several ways. A structured data source such as a spreadsheet, XML file, database and the like may be used to record picture objects and the time they occurred. The techniques and methods described herein may be effectuated using a variety of hardware and other techniques that persist data and any of the ones specifically described herein are by way of example only and are not limiting in any way. In particular, as disclosed herein, images and audio signals representing various characteristics of a signal source may be stored as structured data. Moreover those signals may be stored as encrypted data and accessed using conventional secure communications methodologies.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Environment and Model

Described herein are certain embodiments of a web-based collaborative programming environment and model for AAC. Certain embodiments of the collaborative environment are separated from assist devices employing those embodiments. In some environments care givers may contribute to the content and vocabulary of a nonverbal individual, even without an assist device. The type of content and manner in which any individual can contribute to the collective programming (their role) is defined by a model as disclosed herein. The environment may include shared libraries of AAC content that is used to build vocabularies. This content may include pictures, sounds and templates. Once the content is programmed, it may be distributed, for example and without limitation, by publishing so it is available to any network enabled AAC device.

According to certain embodiments, the environment may include a web-based “designer” application (DA). The designer application may be built on the widely used LAMP stack (Linux, Apache, MySQL, PHP) platform. The DA may reside in a hosted environment and is available to anyone with a network connected computer using conventional web browsers such as Internet Explorer, Firefox, Chrome and Safari.

Caregivers (e.g. parents, SLPs, AT Specialists, teachers and the like) may interact with the environment through a browser on a network connected device such as a PC, Mac tablet computer and the like. The application code, database, images and sounds that make up the collaborative environment may reside on one or more application servers at a hosted site, they may be aggregated through services such as those used in cloud computing or otherwise constructed using the equipment and techniques described herein. It is noted that caregivers do not need to be in the same location. They can work on adding AAC content for a particular child or common content for a group or an entire organization independently. As the content is not developed for a particular assist device, they can develop and test how it will work for users without transferring an assist device from place to place.

### Albums

A caregiver creates picture objects as described herein and organizes them into vocabularies call albums. After a caregiver publishes an album for a person using AAC, the album may be uploaded to any supported user device through a network connection. The collaborative environment supports portable devices such as those described in FIG. 1 and related text. Because the published albums are on the network, they can be downloaded immediately to any device. In certain embodiments each device may have a platform-specific player application (sometimes called a TapToTalk Player) installed on the device. The player is programmed to play the published AAC content.

An application for a specific device (“app”), for example an iPhone/iPad app, may be developed using the IOS Software Development Kit and distributed through Apple's App Store. A Nintendo app may be developed using an Open Source game SDK such as devkitPro. This allows for operation on an open source game cartridge designed for the Nintendo DS family. This special cartridge uses a microSD card to store both the Nintendo App and published data. A web app may be implemented in hypertext markup language (HTML) and JavaScript for compatibility with common web browsers. The web app may be used on standard PCs and Macs, Tablet PCs and Smartboards.

To access the collaborative environment in some embodiments, the caregiver logs in using a unique ID and password. This identifies to the system which particular device, programs and albums that the user has rights to “program”. For example the caregiver's email address and a password that they create may be used to log in to the system.

### Content in Shared Libraries

In some embodiments, there may be a set of libraries that can be accessed and shared by all caregivers within an organization. An organization could be a school system, a large group of SLP practitioners or a single special needs school. One user in the organization may be designated as the administrator; the administrator assigns access privileges for individual caregivers within the organization. An implementation may include the following libraries:
A shared picture library
A shared sound library
A shared album library

In accordance with aspects of the current disclosure, a picture object is the foundational ACC object. It may be constructed of one or more of the following:
Graphic—The graphic may be supplied from any source, for example and without limitation, copied from a set of standard bitmaps provided by the application vendor, or alternatively uploaded to the server from the caregiver's computer. Graphics may be standard image files such as jpg, gif, bmp, png formats and the like. They may also be graphical images or digital photos.
Text—A caption and/or description that is displayed on the user's device to assist in identifying the meaning of the picture.
Sound—A recorded word or phrase that is played when the user touches the picture on the device.

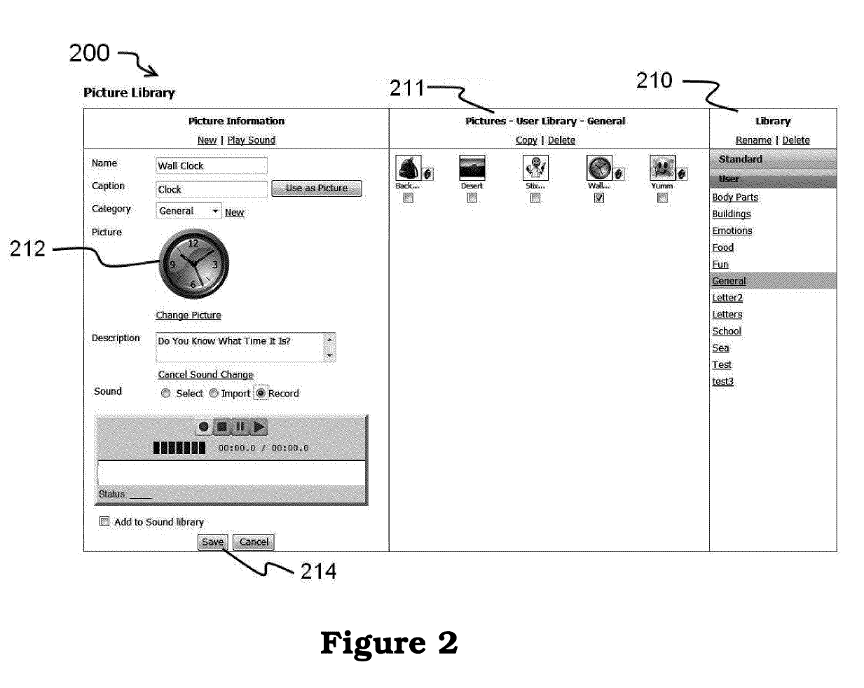

FIG. 2 shows an embodiment of a picture library 200. In FIG. 2 an image of a clock is used to exemplify certain aspects of a collaborative programming ACC system. A user selects the category from the library 210. The categories represent different topics used by people when communicating. Once a category is selected, the user then selects one of the pictures from the user library 211. In this example, an image of a clock will appear on the device, with a caption of “Clock” when selected.

In operation, when the image is touched or otherwise selected by the user, the Description phrase “Do you know what time it is?” would appear on the screen and the recorded phrase would be “spoken” by the device using an speaker or other audio transducer. The user may add text, record phrases and upload images using the embodiment shown in FIG. 2.

Once the picture object is created, the caregiver can save it to the Picture Library to be used by others within the organization by selecting the Save button 214. Saving allows the organization to define standard vocabulary objects that are used by all caregivers within the organization. The vocabulary objects are saved in the shared library with a descriptive name and category. In the above example, the picture's name is “Wall Clock” and it is saved in the general category. The names and categories can be specified by any caregiver with proper access privileges. Once a vocabulary object is added to the shared library, it is available to be copied into a particular user's vocabulary set or album.

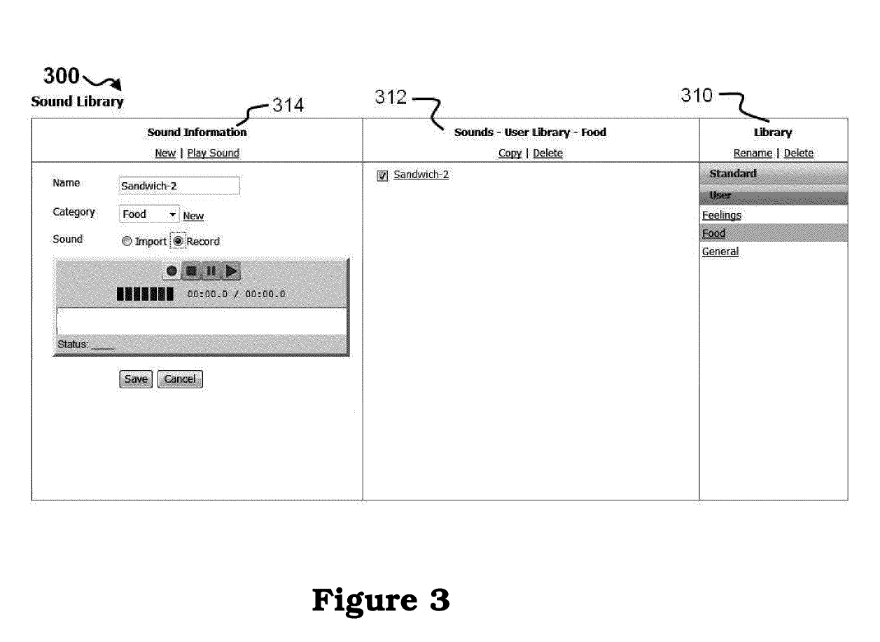

FIG. 3 illustrates a sound library 300. The sound library includes a master library 310, a user library 312 and sound information controls 314. In certain embodiments, a sound may be a recorded phrase or word. The sound may be recorded directly from the caregiver's computer using a Javabased recording control, generated using a text-to-speech process or imported into the system using conventional methods to upload files. These files may be without limitation .wav, .mp3, .wma sound files and the like. The caregiver gives the sound an identifying name and assigns it a category in the web form shown in FIG. 3 prior to saving it. Once saved in the shared sound library, it is available for other caregivers within the organization to associate with a picture. This allows an organization to create a standard set of words and phrases recorded in a consistent manner to be shared within the organization.

In the example shown in FIG. 3, the caregiver recorded the phrase “May I have a sandwich?” using the recording controls. It is now available for use by any caregiver within the organization to associate with different pictures representing a sandwich or other image as a user may select. For example and without limitation, the caregiver might choose a graphic of a submarine sandwich. For another, a photo of a sandwich on white bread would be better suited. However, a consistent recorded phrase from the library can be associated with either picture.

### Text to Speech

Certain embodiments may include a text-to-speech tool for generating sounds. This may be effectuated using a conventional speech synthesizer implemented in either software or hardware. A text-to-speech (TTS) system converts normal language text into speech and may also renders symbolic linguistic representations like phonetic transcriptions into speech.

Synthesized speech may be created by concatenating pieces of recorded speech that are stored in a database. Systems differ in the size of the stored speech units; a system that stores phones or diphones provides the largest output range, but may lack clarity. For specific usage domains, the storage of entire words or sentences allows for high-quality output. Alternatively, a synthesizer can incorporate a model of the vocal tract and other human voice characteristics to create a completely “synthetic” voice output.

### Collaborating on a User's Albums

In some embodiments according to the current disclosure, an album is a set of pictures arranged in an outline programmed to meet the vocabulary needs of a specific user. Organizations might program standard outline arrangements that are effective for a specific population of users. For example and without limitation, an SLP might define a “template” album that meets the broad needs of most boys with autism between the ages of 8-10 when they are attending classes. By adding the album to a shared album library, other professionals or a parent can copy this template album into another child's set of albums and add or modify the pictures in the album to meet the specific needs of the other child.

In some embodiments multiple caregivers can work on a set of albums for a particular user. A collection of albums for a user is called a TapToTalk. Each TapToTalk is “owned” by a caregiver who may grant sharing privileges to other caregivers. The collaborative model supports multiple caregivers working at the same time on multiple albums for a single TapToTalk. Caregivers may also work on template albums directly in the album library because they are not in a particular TapToTalk, but instead are developed as a shared resource.

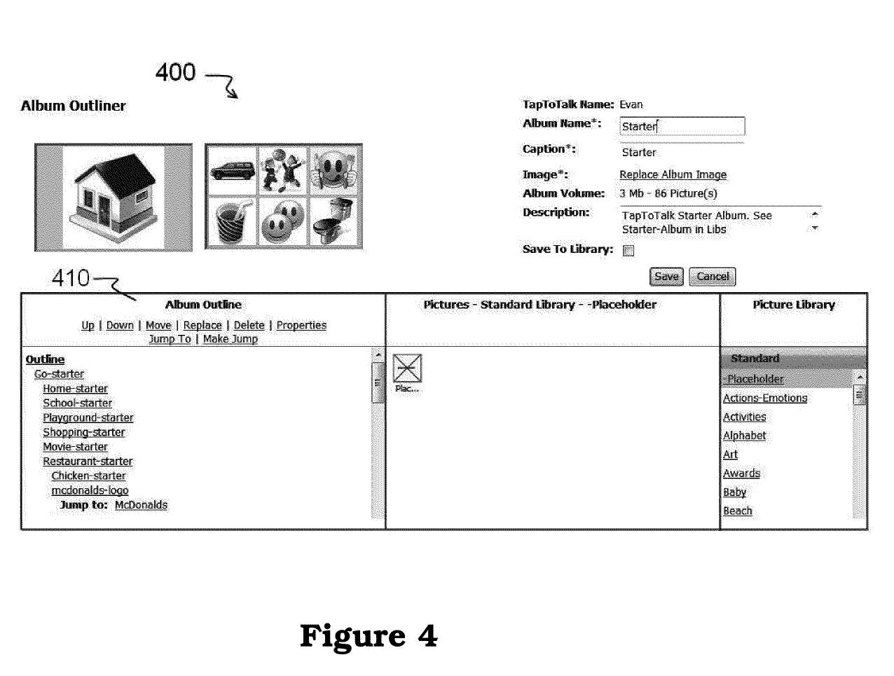

FIG. 4 shows an embodiment of an album outliner 400. In certain embodiments programming a vocabulary includes arranging the picture objects in a “drill down” or outline. The album becomes a complete vocabulary for a particular environment such as homes, restaurants, schools and the like. The album outliner allows caregivers to create vocabularies (i.e. Add/Edit albums). The album outliner tool supports both development and testing of the album.

The use of an outline provides for grouping certain operations together in a logical order. As shown in the album outliner 410, an outline may provide for a restaurant generally, then a food type and then a specific restaurant. Notably the outline may specify one or more next picture objects wherein once a picture object is selected and creates the associated audio sound, the outline shifts thus presenting further picture objects. For example and without limitation, a user may select a picture object that says “I want a hamburger.” The outline will then move to a selection of picture objects representing different drinks or side dishes associated with a hamburger (i.e. “I would like a cola.” or “With fries”). This eliminates the need to fumble through the outline to identify the next most likely choice of a picture object.

Testing may be done on the same screen as the outline is being built through the use of an emulator. The emulator is itself one embodiment of a TapToTalk application. A user may click on a picture thus emulating a user's tap on a supported device. The emulator plays back the recordings and goes to the next level of pictures as shown in the Album Outline 410. Using the emulator, a caregiver can develop fully tested albums and group them by level depending upon the application for the selected album. This provides for creation of functional units in response to a desired activity, for example and without limitation, going to a restaurant. Moreover, the album outliner provides for creation of an album independent of any actual device, thus making the albums device independent.

### Vocabulary Development Process

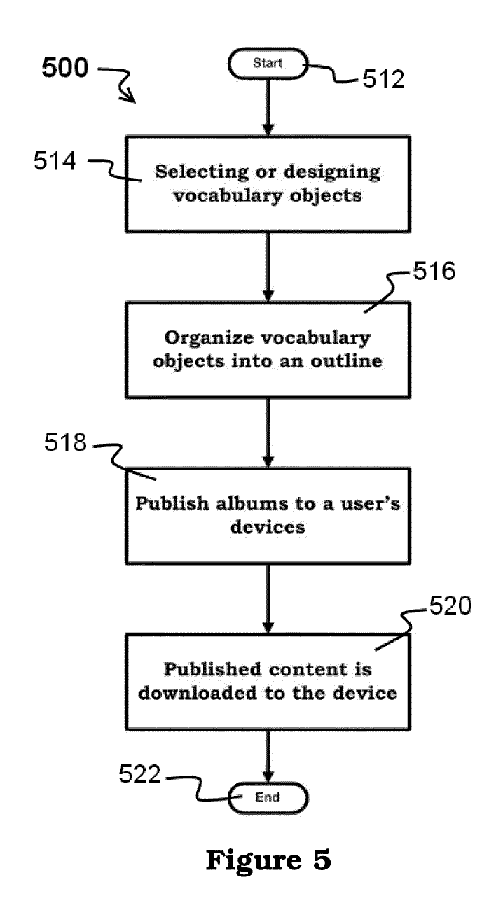

FIG. 5 shows a method for collaboration 500. The method of FIG. 5 may be an iterative process if needed. In FIG. 5 the method begins at a flow label 510.

At a step 514 an author (or caregiver) selects or designs vocabulary objects. This is effectuated by a caregiver selecting a picture or a picture object from the shared picture library. The user may selected an existing picture object and use it as is.” Or a user may modify a picture, text and/or sound to meet the needs of the intended user and create a picture object with the result. Alternatively an author may import a new image and design a new object for sharing. This may be effectuated by adding it to the shared picture library for use by others. Alternatively an author may also choose to share a recording created for a picture object by adding it to the shared sound library for use by others.

At a step 516 a caregiver organizes picture objects into an outline. At this step a caregiver may choose to build a new outline or start from a template in the shared album library. The caregiver chooses which shared libraries to use. For example and without limitation, a caregiver may choose a shared standard library with pictures supplied by vendor or a shared organization library having pictures designed and shared by others.

At this step 516 a caregiver also chooses a category. When a category is chosen, thumbnails of the picture objects for that category are displayed. Once thumbnails are displayed, a caregiver adds the picture to the outline by clicking on the picture. At this stage the caregiver may test the vocabulary using a device emulator.

The categories include events such that the audio is that which is appropriate for the event. For example and without limitation, going to a restaurant or the cinema or to a class. Moreover the category may include a situation such as need to use a restroom or ride public transit. Accordingly the categories may be topical and provide for events and situations where the assisted speech is required. When the album outline is complete the caregiver saves the album.

At a step 518 the author publishes one or more albums to a user's devices by selecting one or more target devices. For example and without limitation, when an author selects a device such as a Nintendo, publishing for the Nintendo application provides all the necessary picture and sound files and a file describing the outline structure. These are packaged into a single file in standard or a compressed (i.e. .zip) format. When published for other devices, the iPhone or iPad for example, all the necessary files, text, pictures and sound files along with a file describing the outline structure are packaged into a single file and saved in a predefined location on a server. When published for a Web App, the text, pictures and sounds are published in a predefined set of directories for that particular user at the server or at another location on the Internet as may be required.

One having skill in the art will recognize that the format and location of the published albums may be varied to meet operational requirements using techniques conventionally associated with client-server processing.

At a step 520 the published content is downloaded to the device. For example and without limitation, code in the AAC device, such as the iPhone or iPad is designed to download the file using one of the many file transfer protocols. The file may also be loaded into a memory device such as a microSD card used by the certain game cartridges (i.e. Nintendo and others). The download process may have password control such that a user first logs in to the server using a password and checks to see if there is a new set of published albums and, if so, downloads them to the device.

As long as the device is communicably coupled to a server, published content is downloaded to the device regardless of location of device. Software instructions on a device instruct the device to un-package the content into a structure appropriate to the platform of the device. Alternatively the published information may be streamed to the device, thus allowing for operation on devices having limited memory or other processing capabilities.

The method ends at a flow label 522.

### Security

In certain embodiments a collection of albums is called a TapToTalk. When a TapToTalk is added to the system, it is assigned a unique, randomly generated 10-digit ID (or GUID). The caregiver or author who added the TapToTalk is designated as its owner. The owner can allow other caregivers in the organization to share the albums in the TapToTalk. For example and without limitation, the owner could be a parent who shares the privilege to create or modify albums and picture object with an SLP. The owner also assigns a password which is used to configure the TapToTalk applications for secure access to published content. The owner may choose not to share or share it in a “view only” mode so that another caregiver cannot make any changes. The owner may also or allow another caregiver to create and modify vocabularies. This model is easily extended to more granular levels of sharing and access privileges.

### Collaboration

In a collaborative environment, an administrative user or owner of a TapToTalk may wish to restrict what particular caregivers can or cannot contribute. For example and without limitation, the parent may desire that a sibling only contribute recorded phrases, but not pictures. In another example, an SLP may only want a parent to review the programmed vocabulary, but not make changes to the structure. One having skill in the art will recognize that this model accommodates many different scenarios. Some of these scenarios may include the following:
A group of collaborators assigns one person as a Supervisor or Administrator. This person is the only one that can add authorized users to the system.
The system administrator or supervisor assigns shared library privileges to individual caregivers thus limiting what they can or cannot do with the shared library resources. These privileges may be “View Only”, “Create/Modify” or “Create/Modify/Delete”. “View Only” caregivers can access vocabulary objects, but cannot add new ones. The others can add new vocabulary objects. Only those with “Delete” privileges can remove vocabulary objects entirely.

### Sharing

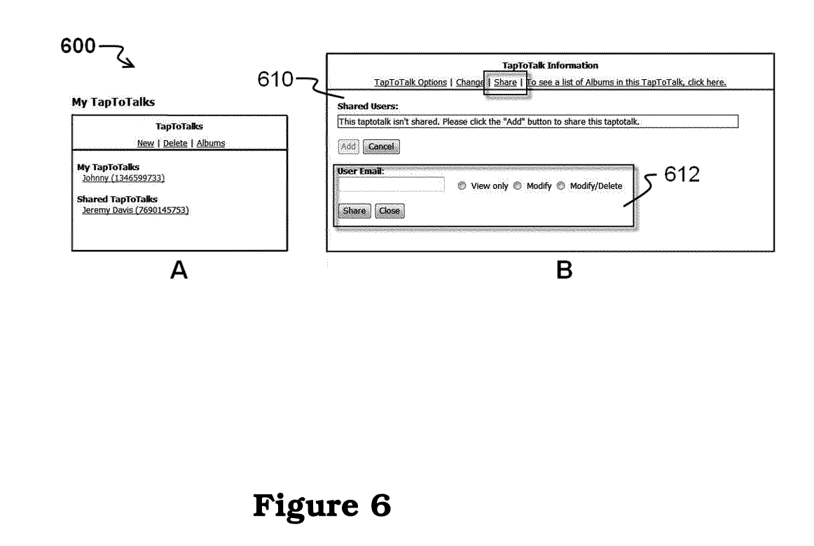

FIG. 6 shows an embodiment for collaborative sharing 600. Sharing allows one user to invite a second user to access a TapToTalk (or elements of a TapToTalk) from within the second user's designer. Sharing provides for control over whether the second user can make changes to TapToTalks (or albums) or simply view them. An example of sharing is the following scenario: A parent has a designer account and works with an SLP who has another designer account. The parent invites the SLP to share her TapToTalk. The SLP accepts the invitation. The SLP now can access the parent's albums from her account rather than using the parent's account. The SLP can copy albums from her album library directly into the parent's album. The parent may then make some modifications. The parent can further individualize the album with family photos and voices. Both the parent and the SLP can publish the albums when they are ready.

In FIG. 6A a user sees the TapToTalks that are owned by that user or shared with other users. The user can create a new TapToTalk or delete a TapToTalk. FIG. 6B shows an embodiment for facilitating the sharing process. FIG. 6B provides for viewing TapToTalks shared with other users in screen region 610 or alternatively showing that the specific TapToTalk is not shared with other users. Control 612 shows an embodiment for sharing, including entering a user's email address and setting the permissions that user would have. Selecting the share button would allow the other user access to the TapToTalk.

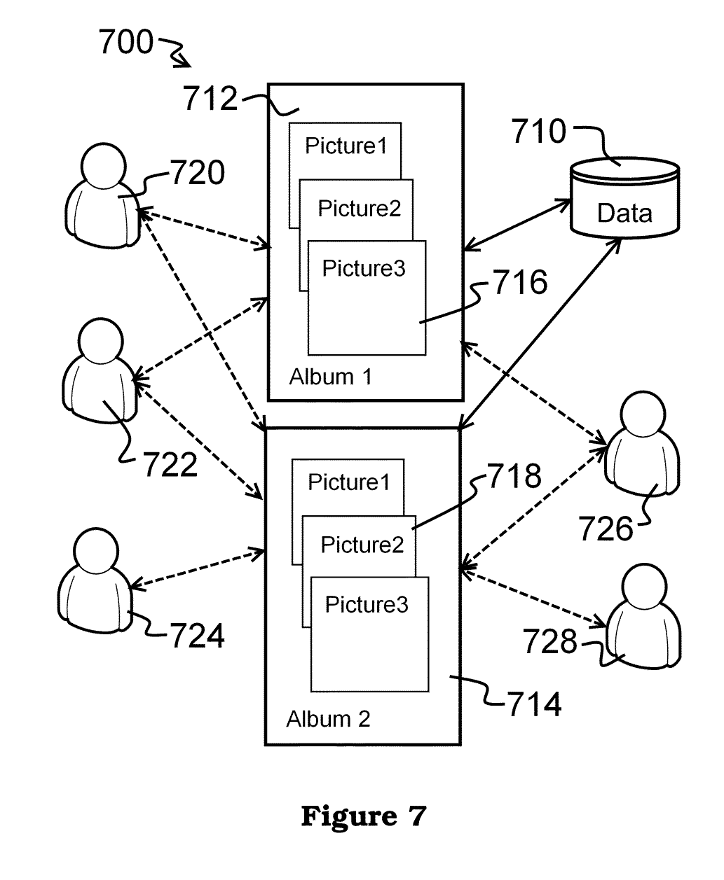

FIG. 7 shows a diagram representing an embodiment of a collaboration model 700. In the drawing a structured data source 710 is operated by a processor based device (not shown) that provides for the user input and displays similar to those shown and described above. Picture objects 716 and 718 are shown organized into albums 712 and 714. Authors (or caregivers) 720-4 have access to and may operate with the albums 712 and 714. Note that different authors may only have access to certain albums and not others as shown. People needing assistance 726 and 728 may also access and use the albums assigned to (or owned by) them.

In operation, as the person needing assistance 726-8 ages or encounters new events and situations, thus learning a larger vocabulary, the caregivers 720-4 can adjust the albums 712 and 714 to reflect the increasing vocabulary. The albums 712 and 714 may be shared or used as templates for others needing assistance.

### Mobile Device Support

Various embodiments may require software for portable devices to operate with the TapToTalks and associated content. As disclosed herein some devices will require software that operates to fetch the outlines, albums and picture object and present them for use. Conventional downloading techniques may be employed to effectuate the fetch operations. Mobile software may present the outline as shown in the above mentioned embodiments or variations on the presentations as shown and described herein. The software operates to display the outline, topics, albums and pictures objects. The display may be fully interactive to allow for selection by topic, album or picture object.

A user would select the desire picture object by stepping through (or drilling down) the outline until the desired album and then picture object is presented. Upon presentation, the user selects the picture object (which may include tapping the screen) and the associated audio will play using the device's audio system and speaker(s). Alternatively the device may be coupled to remote speakers or a remote audio system thus allowing for different means of playing the associated audio.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method including:
presenting picture object information, said picture object including at least a graphic and an audio file;
presenting topic selection information;
receiving topic information in response to said presenting;
associating the picture object with the topic, and
publishing the picture object and the topic, said publishing including
presenting the picture object and the topic to a plurality of users.

2. The system of claim 1 wherein publishing further includes:
receiving commands operable to play the audio file through a speaker in response to a user selecting the picture object.

3. The system of claim 2 wherein the publishing further includes:
displaying a different topic in response to said commands.

4. The system of claim 1 further including:
receiving a graphic, said receiving including either uploading a graphic file, selecting a graphic from a list provided by a vendor, or selecting one from a list of previously stored graphic files.

5. The system of claim 1 further including:
receiving an audio file, said receiving including either uploading an audio file, selecting an audio file from a list provided by a vendor, or selecting one from a list of previously stored audio files.

6. A system including:
a display engine, said display engine operative to:
receive a graphic;
receive an audio file;
associate said graphic and file to a topic, and
an execution engine, said execution engine operable to:
persist the graphic, file and topic in memory, and
publish the graphic, file and topic.

7. The system of claim 6 wherein the audio file represents an element of human speech and the graphic is identified with the human speech.

8. The system of claim 6 wherein receive a graphic includes either uploading a graphic file, selecting a graphic from a list provided by a vendor, or selecting one from a list of previously stored graphic files.

9. The system of claim 6 wherein receiving an audio file includes either uploading an audio file, selecting an audio file from a list provided by a vendor, or selecting one from a list of previously stored audio files.

10. The system of claim 6 wherein publishing includes downloading to a mobile device, said mobile device including a display and a speaker,
wherein when a user selects the graphic, the audio file plays.

11. The system of claim 6 wherein the display engine is further operable to:
associate second graphics and second audio files with one or more topics; and
associate the second topics to the topic; and
the execution engine is further operable to display the one or more second topics in response to a user selecting the topic.

12. The system of claim 6 wherein publishing includes presenting a browser window, said browser window including controls to select the graphic, and in response to said selecting, edit the graphic or the audio file.

13. The system of claim 6 wherein the topic is an event or situation.

14. The system of claim 6 wherein the display engine is further operable to:
associate a second graphic and a second audio file with the topic.

15. A method comprising:
receiving a plurality of graphics and audio files, each of said graphics associated with an audio file and a topic;
receiving outline information, said outline associating the graphics and audio files with events or situations, and
publishing the outline, graphics and audio files.

16. The method of claim 15 wherein said receiving outline information includes:
presenting an outline to a user;
receiving alternative outline information from the user, and
altering the outline in response to the alternative outline information.

17. The method of claim 15 wherein publishing the outline includes:
transferring the outline to a remote device,
wherein a user selects a topic and an image and the audio file plays.

18. The method of claim 17 wherein further including:
changing the topic in response to said user's selection.

19. The method of claim 15 wherein publishing the outline includes:
transferring the outline, image and audio file to a server, said server includes program instructions operable to edit the outline,
wherein multiple users having access to said server may edit the outline.

20. The method of claim 15 wherein the topic relates to an event or situation and the audio file represents a human voice.
